(19) United States
(12) Patent Application Publication
(10) Pub. No.: US 2015/0322898 A1
(43) Pub. Date: Nov. 12, 2015

(54) HEAT EXCHANGER FOR EXHAUST GAS RECIRCULATION UNIT

(71) Applicant: Caterpillar Inc., Peoria, IL (US)

(72) Inventor: Robert J. Chesney, Peoria, IL (US)

(73) Assignee: Caterpillar Inc., Peoria, IL (US)

(21) Appl. No.: 14/271,696

(22) Filed: May 7, 2014

(51) Int. Cl. F02M 25/07

(52) U.S. Cl. CPC F02M 25/0726

(57) ABSTRACT

A heat exchanger for an exhaust gas recirculation unit is provided. The heat exchanger includes a tube core having a plurality of exhaust gas tubes and at least one coolant channel disposed between the plurality of exhaust gas tubes. The heat exchanger further includes a flow conditioner fluidly coupled to the heat exchanger. The flow conditioner includes an inlet port and an outlet port. The outlet port is fluidly coupled to the plurality of exhaust gas tubes. The flow conditioner further includes a plate extending at least partially between the inlet port and the outlet port. The plate is configured to control the exhaust gas flow from the inlet port to the outlet port.

### TECHNICAL FIELD

The present disclosure relates to an exhaust gas recirculation unit, and more specifically to a heat exchanger of an exhaust gas recirculation unit.

### BACKGROUND

An exhaust gas recirculation (EGR) heat exchanger, also known as an EGR cooler, is a component associated with an EGR unit for use with an engine. The EGR unit is generally installed in order to reduce emissions, specifically of nitrous oxides (NOx), in order to meet increasingly stringent emission level requirements. In some applications, the EGR heat exchanger may be subjected to high thermal stress, specifically an exhaust inlet face of the EGR heat exchanger may be particularly stressed. The exhaust inlet face is generally brought in contact with a heated exhaust gas flow received from an exhaust manifold of the engine. This high thermal stress may lead to premature failure of the EGR heat exchanger.

U.S. Pat. No. 7,565,800 discloses a combustion engine exhaust assembly. The assembly includes an exhaust gas passageway of a turbocharger, such as in an inlet of the turbocharger. The exhaust gas passageway includes a divider plate assembly. The divider plate assembly includes a body and a divider plate, where at least one of the body and the divider plate are generally formed from a material resistant to at least one of extreme temperature conditions, extreme thermal gradient conditions, and extreme loads. The divider plate assembly is useful in distributing exhaust gases within an exhaust assembly and is generally capable of extending the useful life of an exhaust manifold.

### SUMMARY OF THE DISCLOSURE

In one aspect of the present disclosure, a heat exchanger for an exhaust gas recirculation unit is provided. The heat exchanger includes a tube core. The tube core includes a plurality of exhaust gas tubes extending from an upstream face to a downstream face of the heat exchanger. The tube core also includes at least one coolant channel disposed between the plurality of exhaust gas tubes. The heat exchanger further includes a flow conditioner fluidly coupled to the upstream face of the heat exchanger. The flow conditioner includes an inlet port disposed along a first plane. The inlet port is configured to receive an exhaust gas flow. The flow conditioner includes an outlet port disposed along a second plane. The outlet port is fluidly coupled to the plurality of exhaust gas tubes. The flow conditioner also includes a passage extending between the inlet port and the outlet port. The flow conditioner further includes a plate disposed within the passage and extending at least partially between the inlet port and the outlet port. The plate is configured to control the exhaust gas flow from the inlet port to the outlet port.

In another aspect of the present disclosure, a flow conditioner for a heat exchanger of an exhaust gas recirculation unit is provided. The flow conditioner includes an inlet port disposed along a first plane. The inlet port is configured to receive an exhaust gas flow. The flow conditioner includes an outlet port disposed along a second plane. The outlet port is fluidly coupled to the plurality of exhaust gas tubes. The flow conditioner also includes a passage extending between the inlet port and the outlet port. The flow conditioner further includes a plate disposed within the passage and extending at least partially between the inlet port and the outlet port. The plate is configured to control the exhaust gas flow from the inlet port to the outlet port.

In yet another aspect of the present disclosure, an engine is provided. The engine includes an exhaust manifold. The engine also includes an intake manifold. The engine further includes an exhaust gas recirculation unit. The exhaust gas recirculation unit includes a heat exchanger fluidly coupled to the exhaust manifold and the intake manifold. The heat exchanger includes a tube core. The tube core includes a plurality of exhaust gas tubes extending from an upstream face to a downstream face of the heat exchanger. The tube core also includes at least one coolant channel disposed between the plurality of exhaust gas tubes. The heat exchanger further includes a flow conditioner fluidly coupled to the upstream face of the heat exchanger. The flow conditioner includes an inlet port disposed along a first plane. The inlet port is configured to receive an exhaust gas flow from the exhaust manifold. The flow conditioner includes an outlet port disposed along a second plane. The outlet port is fluidly coupled to the plurality of exhaust gas tubes. The flow conditioner also includes a passage extending between the inlet port and the outlet port. The flow conditioner further includes a plate disposed within the passage and extending at least partially between the inlet port and the outlet port. The plate is configured to control the exhaust gas flow from the inlet port to the outlet port.

Other features and aspects of this disclosure will be apparent from the following description and the accompanying drawings.

### BRIEF DESCRIPTION OF THE DRAWINGS

FIG. 1 is an illustration of an exemplary machine, according to an embodiment of the present disclosure;

FIG. 2 is a cross sectional view of a heat exchanger for an exhaust gas recirculation unit of the machine along an axis X-X′, according to an embodiment of the present disclosure;

FIG. 3 is a perspective view of an exemplary flow conditioner, according to an embodiment of the present disclosure;

FIG. 4 is a perspective view of another embodiment of the exemplary flow conditioner, according to the present disclosure; and

FIG. 5 is a perspective view of yet another embodiment of the exemplary flow conditioner, according to the present disclosure.

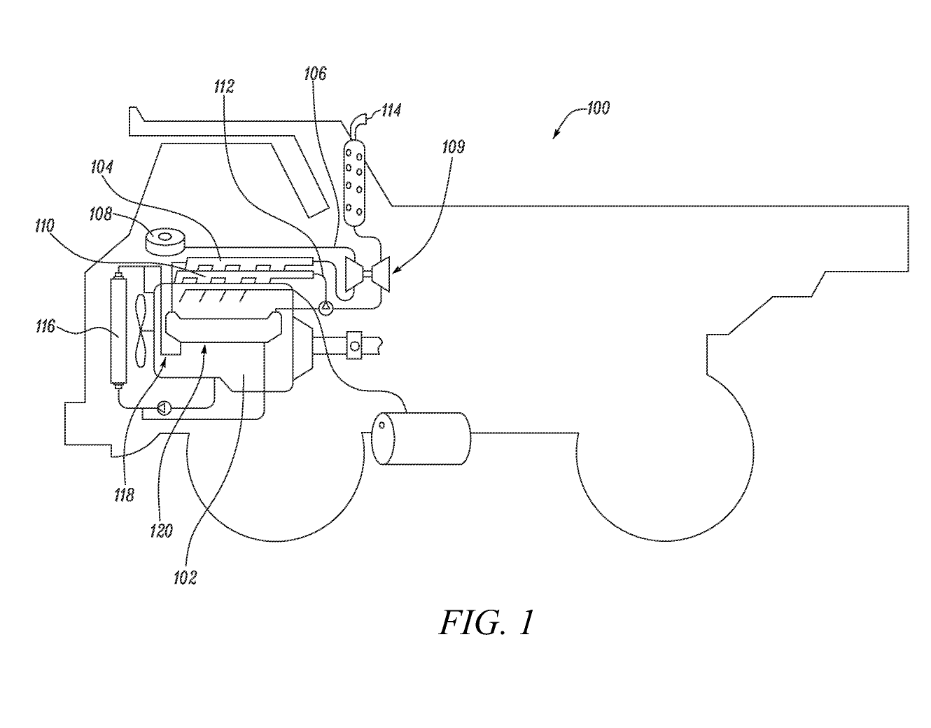

### DETAILED DESCRIPTION

Wherever possible, the same reference numbers will be used throughout the drawings to refer to the same or the like parts. FIG. 1 illustrates an exemplary machine 100, according to one embodiment of the present disclosure. The machine 100 illustrated in the accompanying figure is a dump truck. It should be noted that the machine 100 may be any other machine, such as a truck used in transportation. The machine 100 may also embody any other type of machine that performs an operation associated with an industry, such as mining, construction, farming, transportation, or any other industry known in the art. For example, the machine 100 may be an off-highway truck, an earth moving machine, such as a wheel loader, an excavator, an articulated truck, a backhoe, a motor grader, a material handler, a ship or a boat and so on. In one embodiment, the term “machine”, as used herein, may also refer to a stationary equipment, such as a generator, that is driven by an engine to generate electricity.

The machine 100 is powered by an engine 102 which is adapted to combust a fuel to release the chemical energy therein and convert that energy to mechanical power. The engine 102 may be a compression ignition engine that combusts diesel fuel. Alternatively, the engine 102 may include a spark ignition engine that is configured to combust gasoline or other fuels such as ethanol, bio-fuel, natural gas and so on.

An intake manifold 104 is disposed over the engine 102 and in fluid communication with combustion chambers (not shown) of the engine 102, in order to direct intake air to be used in the combustion process to the engine 102. The intake manifold 104 may be configured to receive intake air from an intake line 106. The intake line 106 in turn may draw atmospheric air through an air intake filter 108. A turbocharger 109 may also be present in the intake line 106 in order to increase an amount of intake air supplied to the engine 102.

An exhaust manifold 110 is provided on the engine 102 and is in fluid communication with the combustion chambers. It should be noted that the arrangement of the intake manifold 104 and the exhaust manifold 110 may vary based on the application. Further, the exhaust gases flowing through the exhaust manifold 110 may be directed to an exhaust line 112 and released into the atmosphere via an exhaust orifice 114.

Further, a coolant system may be fluidly coupled to the engine 102 for removing the heat produced by the engine 102 and thus, facilitating cooling of the engine 102. The coolant system may include a radiator 116 in fluid communication with the engine 102, in order to dissipate heat from a coolant leaving the engine 102. Further, the relatively cooled coolant leaving the radiator 116 may be returned to the engine 102. A person of ordinary skill in the art will appreciate that any known heat exchanger may be utilized as the radiator 116. It should be understood that the connections formed between the various components described herein is exemplary. The system may include other components without deviating from the scope of the present disclosure.

The engine 102 includes an exhaust gas recirculation (EGR) circuit 118 configured for reducing the emissions produced by the combustion process. More specifically, the EGR circuit 118 includes passageways fluidly connecting an EGR unit 120 to the exhaust manifold 110 and the intake manifold 104 of the engine 102. The EGR unit 120 is configured to redirect at least a portion of the exhaust gas flow discharged from the combustion process back into the intake manifold 104 for intermixing with the intake air. One of ordinary skill in the art will appreciate that the presence of exhaust gas in the intake air may lower the relative proportion or amount of oxygen available for combustion in the combustion chamber, in turn resulting in a lower flame and/or combustion temperature.

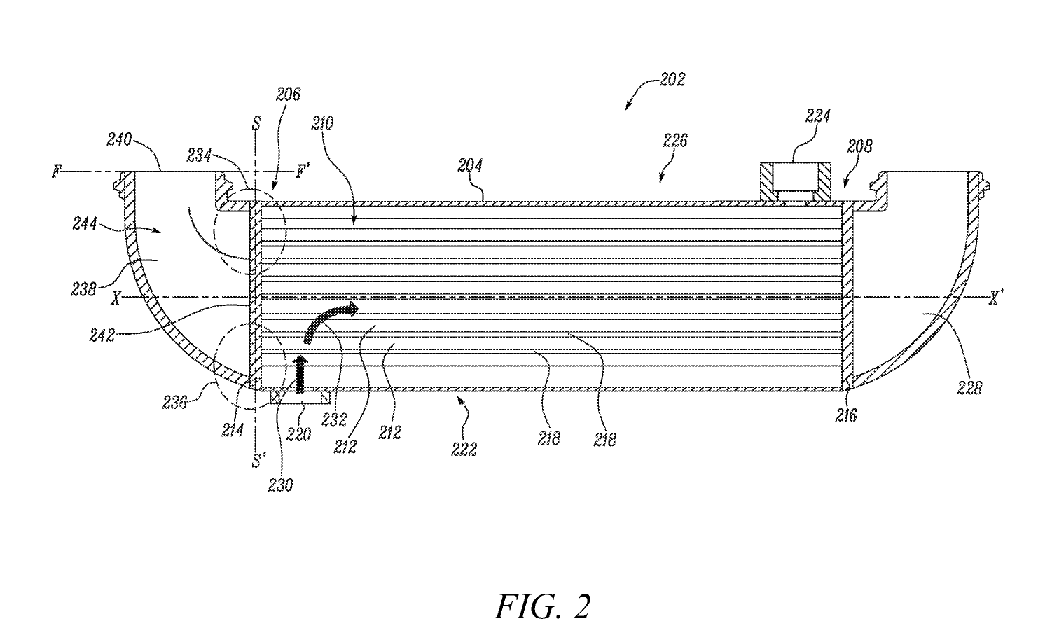

Referring to FIG. 2, a cross sectional view of a heat exchanger 202 along a longitudinal axis X-X′ associated with the EGR unit 120 is illustrated. The heat exchanger 202 is fluidly coupled to the exhaust manifold 110 and the intake manifold 104 as will be described in more detail below. The heat exchanger 202 is configured to cool the exhaust gas flow. One of ordinary skill in the art will appreciate that the heat exchanger 202 disclosed herein is a shell-and-tube heat exchanger in which hollow tubes conducting one medium is enclosed in a shell containing the other medium that flows around and past the tubes.

The heat exchanger 202 includes an elongated core shell 204 extending between an upstream face 206 and a downstream face 208, defining the longitudinal axis X-X′. The heat exchanger 202 includes a tube core 210 provided within the core shell 204. The tube core 210 includes exhaust gas tubes 212 extending from the upstream face 206 to the downstream face 208. The exhaust gas tubes 212 are positioned in a parallel arrangement, wherein each of the exhaust gas tubes 212 are spaced apart from each other. Further, the exhaust gas tubes 212 are aligned parallel to the longitudinal axis X-X′ of the heat exchanger 202. The exhaust gas tubes 212 may be made from any suitable material, such as a metal or metal alloy like aluminum or an aluminum alloy, copper or a copper alloy, and so on.

The exhaust gas tubes 212 are fixed to an upstream header plate 214 at the upstream face 206 of the tube core 210. The exhaust gas tubes 212 are also fixed to a corresponding downstream header plate 216, placed at the downstream face 208 of the tube core 210. The upstream header plate 214 and/or the downstream header plate 216 are configured to securely hold and maintain the position of the exhaust gas tubes 212 within the heat exchanger 202. In one embodiment, the exhaust gas tubes 212 may be mechanically coupled to the upstream header plate 214 and/or the downstream header plate 216, for example, via welding, brazing or soldering. Alternatively, the exhaust gas tubes 212 may be integral with the upstream header plate 214 and/or the downstream header plate 216. The upstream header plate 214 and the downstream header plate 216 may be flat plates of a heat resistant material, such as steel, aluminum, aluminum alloy, ceramic and so on arranged perpendicular to the longitudinal axis X-X′ of the tube core 210.

The tube core 210 includes coolant channels 218 disposed between the exhaust gas tubes 212. In another embodiment, the tube core 210 may include a single coolant channel 218 disposed between the exhaust gas tubes 212. Alternatively, the coolant channels 218 may be formed by spaces created between the exhaust gas tubes 212. The coolant channels 218 are configured to provide a coolant flow within the heat exchanger 202. A coolant loop may be formed by the coolant channels 218 disposed within the heat exchanger 202, in order to cool the exhaust gas flow and will be explained later in detail. Accordingly, the coolant channels 218 are disposed in such a manner so that a direction of the coolant flow within the heat exchanger 202 is substantially parallel to the direction of the exhaust gas flow inside the tube core 210.

The heat exchanger 202 includes a coolant inlet 220 provided on the core shell 204. The coolant inlet 220 is fluidly coupled to the coolant channels 218. The coolant inlet 220 may be integrated with the core shell 204. Alternatively, any suitable type of removable connection such as a hose barb, a threaded hose fitting, a quick-release fitting, or a permanent connection such as, for example, a connection done by welding or brazing, may be utilized for connecting the coolant inlet 220 to the coolant channels 218. The coolant inlet 220 may be a hollow tube through which the coolant may flow. The coolant inlet 220 may therefore introduce the coolant flow into the coolant channels 218.

The coolant inlet 220 is positioned proximate to the upstream face 206 of the heat exchanger 202. More specifically, the coolant inlet 220 is provided along a first side 222 of the upstream face 206 of the tube core 210. It should be noted that the proximity in the positioning of the coolant inlet 220 may be such that the coolant flow is introduced at the upstream face 206 of the tube core 210. Accordingly, in one embodiment, the coolant inlet 220 may be positioned in a first quarter section of the tube core 210. The first quarter section of the tube core 210 may include a length of the tube core 210 extending from the upstream face 206 to one fourth of the length of the tube core 210 adjacent to the upstream face 206. In another embodiment, a number of additional coolant inlets (not shown) may be provided along the length of the tube core 210.

The heat exchanger 202 includes a coolant outlet 224 provided on the core shell 204. The coolant outlet 224 is fluidly coupled to the coolant channels 218. The coolant outlet 224 may be integrated with the core shell 204. Alternatively, any suitable type of removable connection such as a hose barb, a threaded hose fitting, a quick-release fitting, or a permanent connection such as, for example, a connection done by welding or brazing, may be utilized for connecting the coolant outlet 224 to the coolant channels 218. The coolant outlet 224 may be a hollow tube through which the coolant may flow. The coolant outlet 224 is configured to discharge the coolant flow from the coolant channels 218.

The coolant outlet 224 is positioned proximate to the downstream face 208 of the heat exchanger 202. More specifically, the coolant outlet 224 is provided along a second side 226 of the downstream face 208 of the tube core 210. It should be noted that the proximity in the positioning of the coolant outlet 224 may be such that the coolant flow is exited at the downstream face 208 of the tube core 210. Accordingly, in one embodiment, the coolant outlet 224 may be positioned in a fourth quarter section of the tube core 210. The fourth quarter section of the tube core 210 may include a length of the tube core 210 extending from the downstream face 208 to one fourth of the length of the tube core 210 adjacent to the downstream face 208. In another embodiment, a number of additional coolant outlets (not shown) may be provided along the length of the tube core 210.

A person of ordinary skill in the art will appreciate that the positioning, orientation, diameter and material used to form the coolant inlet 220 and the coolant outlet 224 may vary without any limitation. In one embodiment, a valve (not shown) may be associated with the coolant inlet 220 and/or the coolant outlet 224. The valve may be configured to control a volume of the coolant flow being introduced and/or exited via the coolant inlet 220 and/or the coolant outlet 224 respectively. The valve may include any known flow control device known in art, and may be actuated hydraulically, mechanically or electronically based on the application.

The heat exchanger 202 also includes an outlet diffuser 228 provided on the downstream face 208 of the heat exchanger 202. The outlet diffuser 228 is fluidly coupled to the exhaust gas tubes 212. Further, the outlet diffuser 228 is fluidly coupled to the intake manifold 104 of the engine 102. The outlet diffuser 228 is configured to provide a passage for the exhaust gas exiting the exhaust gas tubes 212 to flow to the intake manifold 104.

During operation of the heat exchanger 202, the coolant received in the coolant channels 218, through the coolant inlet 220, flows substantially perpendicular to the coolant channels 218, as illustrated by an arrow 230. Subsequently, the coolant flow may take a turn of approximately 90 degrees to flow through the coolant channels 218 to the coolant outlet 224 as illustrated by an arrow 232. This may result in a relatively lower volume of the coolant flow to circulate through an upper region 234, located on the upstream face 206 of the tube core 210 at the second side 226, relative to a lower region 236 located on the upstream face 206 of the tube core 210 at the first side 222. As a result, the upper region 234 tends to experience higher temperatures, and thus higher thermal stress relative to the lower region 236. Unless steps or features are taken to mitigate it, the higher thermal stress may result in structural failure at the upper region 234 causing cracks to develop in the tube core 210 at the upper region 234.

One of ordinary skill in the art will appreciate that additional components not described herein may also be included in the system. For example, a number of ports (not shown) may be provided on the heat exchanger 202 at one or more locations for venting of air during filling of the coolant. The exhaust gas tubes 212 may have features (not shown) to enhance heat transfer, such as fins, dimples, and so on. Additionally, the embodiment of the heat exchanger 202 described herein has a single pass design in which the two conducting mediums make a single pass through the heat exchanger 202. The disclosure may also be applicable to a multi-pass arrangement in which the conducting mediums are directed to make multiple passes through the heat exchanger 202 without deviating from the scope of the present disclosure.

FIG. 2 illustrates a flow conditioner 238 fluidly coupled to the upstream face 206 of the tube core 210. The flow conditioner 238 includes an inlet port 240 disposed along a first plane F-F′. The inlet port 240 is fluidly coupled to the exhaust manifold 110 of the engine 102 and is configured to receive the exhaust gas flow therefrom. The flow conditioner 238 includes an outlet port 242 disposed along a second plane S-S′. The second plane S-S′ is substantially perpendicular or inclined to the first plane F-F′. The outlet port 242 is fluidly coupled to the exhaust gas tubes 212. The flow conditioner 238 includes a passage 244 extending between the inlet port 240 and the outlet port 242. The passage 244 is configured to provide a flow path for the exhaust gas from the inlet port 240 to the outlet port 242.

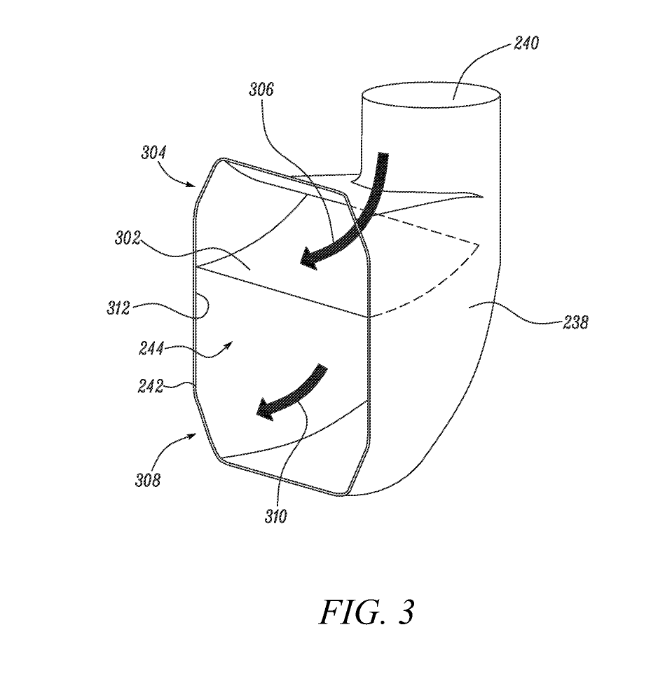

Referring to FIG. 3, a perspective view of the flow conditioner 238 is illustrated, according to an embodiment of the present disclosure. The flow conditioner 238 includes a plate 302 provided within the passage 244 extending at least partially between the inlet port 240 and the outlet port 242. More specifically, the plate 302 is provided adjacent to the outlet port 242 and extends towards the inlet port 240 within the passage 244. The plate 302 has a curvilinear configuration. Further, the plate 302 is configured to control the exhaust gas flow from the inlet port 240 to the outlet port 242.

For example, during operation of the engine 102, a portion of the exhaust gas flowing in an upper section 304 of the flow conditioner 238, as shown by an arrow 306, may tend to swirl due to a small radius of curvature of the flow conditioner 238 in the upper section 304. In contrast, a portion of the exhaust gas flowing in a lower section 308 of the flow conditioner 238, as shown by an arrow 310, may tend to flow uniformly due to a relatively larger radius of curvature of the flow conditioner 238 in the lower section 308. The plate 302 may reduce the swirling of the exhaust gas flow in the upper section 304 by providing a uniform flow path to the exhaust gas. Additionally, the plate 302 is provided within the passage 244 in the upper section 304. This may provide a smaller volume of the exhaust gas to flow therethrough relative to the volume of the exhaust gas flow in the lower section 308. The arrangement of the plate 302 may bias the exhaust gas flow to the lower section 308. As a result, a larger volume of the exhaust gas may flow through the lower region 236 which is closer to the coolant inlet 220 (shown in FIG. 2). As a lower volume of the exhaust gas may flow through the upper section 304, the upper region 234 of the tube core 210 (shown in FIG. 2), which receives a relatively lower volume of the coolant, may experience similar temperatures to that of the lower region 236.

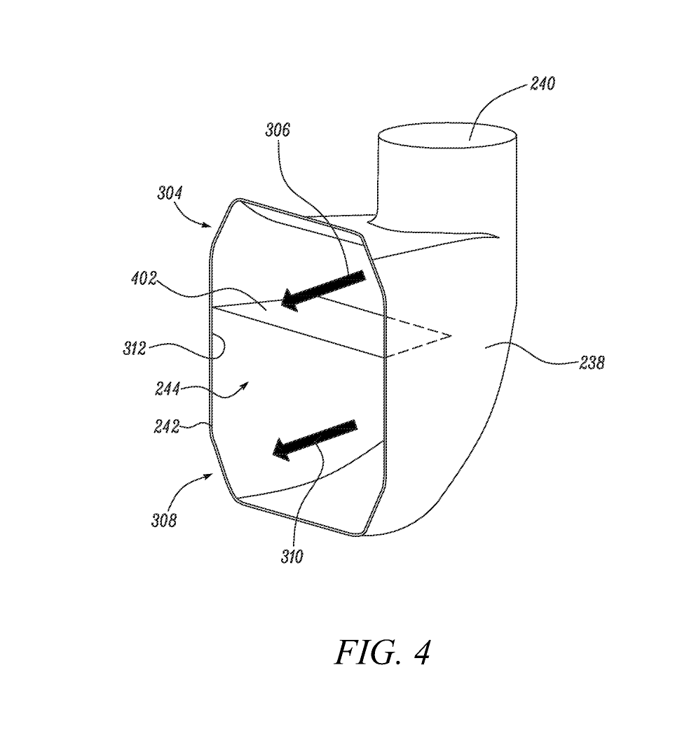

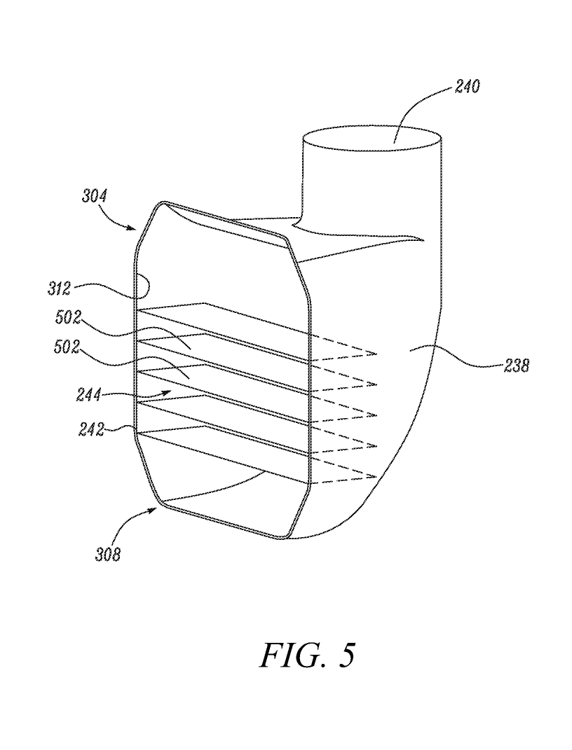

The plate 302 provided in the flow conditioner 238 may have different configurations. For example, in an embodiment, as shown in FIG. 4, the plate 402 may have a planar configuration. The location of the plate 402 may be similar to that described in relation to FIG. 3 or may vary as per system design and requirements. Additionally, in another embodiment, as shown in FIG. 5, the flow conditioner 238 may be provided with multiple plates 502. Each of the plates 502 may be equispaced relative to each other. Further, each of the plates 502 may have the curvilinear configuration, the planar configuration or a combination thereof.

It should be noted that the plate 302, 402, 502 may be formed by any known manufacturing process such as hot working, cold working, shearing, stamping and so on. The plate 302, 402, 502 may be made of any metal or an alloy known in the art as per system requirements. The plate 302, 402, 502 may be coupled to an inner surface 312 of the flow conditioner 238 by any known fastening methods, such as welding, brazing and so on. Alternatively, the plate 302, 402, 502 may be cast integrally with the flow conditioner 238 to form a single component. Location, orientation and/or positioning of the plate 302, 402, 502 within the flow conditioner 238, number, dimensions of the plate 302, 402, 502, and spacing between each of the plates 502 may vary as per system design and requirements and may not limit the scope of the disclosure.

### INDUSTRIAL APPLICABILITY

During operation of an engine, exhaust gas flow is received in exhaust gas tubes of a heat exchanger at an upstream face. The coolant flow received through a coolant inlet may take an approximately 90 degree turn to flow to a coolant outlet. As a result, a rate of coolant flow and/or volume of the coolant received in an upper region located at the upstream face is significantly lower than the rate of coolant flow and/or volume of the coolant in a lower region located at the upstream face. This may cause higher thermal stress to be experienced in the upper region relative to the lower region. Higher thermal stress may result in premature failure of the heat exchanger such as development of cracks in exhaust gas tubes, an upstream header plate, a core shell and so on.

The present disclosure relates to the flow conditioner 238 having the plate 302, 402, 502 disposed within the passage 244. The plate 302, 402, 502 may reduce the swirling of the exhaust gas flowing through the upper section 304, as shown by the arrow 306, by providing a uniform flow path therethrough. The plate 302, 402, 502 may also bias the exhaust gas flow such that a larger volume of the exhaust gas flows through the lower section 308, as shown by the arrow 310, and further through the lower region 236 which receives a substantially larger volume of the coolant flow for cooling. Such an arrangement results in overall lower temperatures and thus, in lowering the thermal stress in the upper region 234 of the heat exchanger 202. Lower thermal stress may reduce the occurrence of structural failure of the exhaust gas tubes 212, the upstream header plate 214, the core shell 204 and so on, thus improving an overall life of the heat exchanger 202.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A heat exchanger for an exhaust gas recirculation unit, the heat exchanger comprising:
a tube core comprising:
a plurality of exhaust gas tubes extending from an upstream face to a downstream face of the heat exchanger; and
at least one coolant channel disposed between the plurality of exhaust gas tubes; and
a flow conditioner fluidly coupled to the upstream face of the heat exchanger, the flow conditioner comprising:
an inlet port disposed along a first plane, the inlet port configured to receive an exhaust gas flow;
an outlet port disposed along a second plane, the outlet port fluidly coupled to the plurality of exhaust gas tubes;
a passage extending between the inlet port and the outlet port; and
a plate disposed within the passage and extending at least partially between the inlet port and the outlet port, the plate configured to control the exhaust gas flow from the inlet port to the outlet port.

2. The heat exchanger of claim 1, wherein the flow conditioner further includes a plurality of plates disposed within the passage and extending at least partially between the inlet port and the outlet port, each of the plurality of plates being equispaced relative to each other.

3. The heat exchanger of claim 1, wherein the plate is curvilinear.

4. The heat exchanger of claim 1, wherein the plate is planar.

5. The heat exchanger of claim 1, wherein the plate is provided adjacent to the outlet port and extends at least partially towards the inlet port.

6. The heat exchanger of claim 1, wherein the first plane is substantially perpendicular to the second plane.

7. The heat exchanger of claim 1, further comprising an outlet diffuser fluidly coupled to the plurality of exhaust gas tubes at the downstream face of the heat exchanger.

8. A flow conditioner for a heat exchanger of an exhaust gas recirculation unit, the flow conditioner comprising:
an inlet port disposed along a first plane, the inlet port configured to receive an exhaust gas flow;
an outlet port disposed along a second plane, the outlet port fluidly coupled to a plurality of exhaust gas tubes of the heat exchanger;
a passage extending between the inlet port and the outlet port; and
a plate disposed within the passage and extending at least partially between the inlet port and the outlet port, the plate configured to control the exhaust gas flow from the inlet port to the outlet port.

9. The flow conditioner of claim 8, wherein the plate is curvilinear.

10. The flow conditioner of claim 8, wherein the plate is planar.

11. The flow conditioner of claim 8, wherein the plate is provided adjacent to the outlet port and extends at least partially towards the inlet port.

12. The flow conditioner of claim 8, wherein the plate is made of a ceramic, a metal or a metallic alloy.

13. The flow conditioner of claim 8, wherein the first plane is substantially perpendicular to the second plane.

14. An engine comprising:
an exhaust manifold;
an intake manifold; and
an exhaust gas recirculation unit comprising:
a heat exchanger fluidly coupled to the exhaust manifold and the intake manifold; the heat exchanger comprising:
a tube core comprising:
a plurality of exhaust gas tubes extending from an upstream face to a downstream face of the heat exchanger; and
at least one coolant channel disposed between the plurality of exhaust gas tubes; and
a flow conditioner fluidly coupled to the upstream face of the heat exchanger, the flow conditioner comprising:
an inlet port disposed along a first plane, the inlet port configured to receive an exhaust gas flow from the exhaust manifold;
an outlet port disposed along a second plane, the outlet port fluidly coupled to the plurality of exhaust gas tubes;
a passage extending between the inlet port and the outlet port; and
a plate disposed within the passage and extending at least partially between the inlet port and the outlet port, the plate configured to control the exhaust gas flow from the inlet port to the outlet port.

15. The engine of claim 14, wherein the flow conditioner includes a plurality of plates disposed within the passage and extending at least partially between the inlet port and the outlet port, each of the plurality of plates being equispaced relative to each other.

16. The engine of claim 14, wherein the plate is curvilinear.

17. The engine of claim 14, wherein the plate is planar.

18. The engine of claim 14, wherein the plate is provided adjacent to the outlet port and extends at least partially towards the inlet port.

19. The engine of claim 14, wherein the first plane is substantially perpendicular to the second plane.

20. The engine of claim 14, further comprising an outlet diffuser fluidly coupled to the plurality of exhaust gas tubes at the downstream face of the heat exchanger, wherein the outlet diffuser is fluidly coupled to the intake manifold of the engine.
